(19) United States
(12) Patent Application Publication
(10) Pub. No.: US 2008/0189069 A1
(43) Pub. Date: Aug. 7, 2008

(54) Comprehensive workflow management system for creating and managing closed-loop tasks for businesses and organizations

(76) Inventor: James Hans Beck, Atascadero, CA (US)

Correspondence Address: LAW OFFICES OF ANDREW Y. SCHROEDER, 500 SOUTH BROADWAY, SUITE 222, SANTA MARIA, CA, 93454, US

(21) Appl. No.: 11/655,466

(22) Filed: Jan. 18, 2007

(51) Int. Cl. G06F 19/00

(52) U.S. Cl. 702/123

(57) ABSTRACT

A comprehensive network-based workflow management system for directing closed-loop tasks for businesses and organizations includes: a network based portal linked to a plurality of web-pages for the purpose of interfacing with a client, at least one business module component, a provider-side server, a plurality of Instructions for the purpose of directing pre-determined tasks, a notification alert system for notifying the client to perform a specific task at a pre-determined time, a system for receiving data inputs from a client through a second communication device, a Measurements System for tracking data inputs, and a provider-side database for the purpose of storing system information

### FIELD OF THE INVENTION

The present invention relates with an apparatus, system, and method of managing businesses remotely using various widely-accepted business fundamentals.

### BACKGROUND OF THE INVENTION

Successful businesses and organizations alike (private sector, public sector, or other non-profit companies) must be simultaneously short-sighted and far-sighted to achieve their goals. They must be short sighted in the sense of accomplishing today's duties with efficiency, precision and fastidious attention to detail. This may require an employee to carefully ensure the proper amount of postage is placed on a package, ensuring that a particular customer is able to quickly get in and out of their store, or cleaning up a puddle on the floor.

Businesses must also be far-sighted in their operations as well. Business leaders must be able to discern trends, cycles, client's moods and tastes, the effect of regional and national government policies on industry and other events which may bring forth profound change in their businesses and respective industries. A far-sighted business leader may be able to capitalize on an untapped need in the marketplace and generate a sizeable profit for his business. In some cases, a far-sighted business leader might be able to figure that using a particular technology or method may be leveraged in order to produce more profit, efficiency and customer satisfaction. Business leaders who fail to heed these trends may lose their customer and client bases quickly thereby threatening the long-term viability of their business.

These contrasting visions may be best analogized in organisms. Most organisms possess a conscious control over their movements and an unconscious or automatic control of their movements. For instance humans have conscious control over their hands, feet and legs for movement. However, other muscular contractions are sub-consciously stimulated and controlled by various autonomic components of the nervous system (e.g. breathing, heart palpitations, and blinking).

It can be theorized that the reasons organisms evolved to have a conscious system and an autonomic system is that if organisms had to consciously think about breathing, heart muscle contractions and the like, they would simply not possess the requisite brain power to actually move and forage for food and avoid predators. In other words, they would not be able to plan a task such as hunting if they had to also think about breathing, digesting food, and pumping blood with their hearts.

Like organisms, businesses also need to be able to perform various minute by minute financially life-sustaining tasks such as sending out invoices, depositing checks, and inventory. In addition, businesses must also be able to perform long-term tasks such as incorporating new software and hardware into their businesses, hiring a new CEO, or moving operations to another country. And with most organisms, businesses simply lack the brainpower and energy to devote equal time and resources to both types of tasks. Typically, the long-term strategic thinking suffers as a result with becoming too fixated with the mundane tasks which should be second nature.

In every business there are various tasks which are predictable, repeatable, and cyclical such as paying bills or performing payroll operations. Furthermore, there are other business processes that appear infrequently. However, even in less-frequently occurring business the tasks are also predictable, repeatable, and cyclical once their tasks are broken down to smaller steps which comprise the operation.

Tasks which are repeatable, predictable and cyclical best lend themselves to mechanistic protocols. Since these tasks could be easily directed with computers and do not require much subjectively qualitative direction it is wasteful to encumber managers and executives to overly-concern themselves with these mundane tasks which could simply be prompted by a computer program.

Currently in the industry there are not many technologies which direct employees, managers, and executives with a carefully planned out protocol of directions. The reason for this is that most businesses are run and operated in a panoply of different styles and protocols. Moreover, most business challenges and tasks vary so much that it may prove difficult to devise a “one size fits all” plan to direct a business.

Another problem which most businesses must deal with is delegating various tasks and assignments to employees and independent contractors and holding them accountable for their assigned tasks and assignments. Often, task assignments are ignored, overlooked or performed with little attention to detail or care. The main reason for this is that management simply cannot keep track of all the tasks and assignments which are delegated and to whom those tasks and assignments those tasks and assignments are delegated. Without close and fastidious supervision of the delegation and performance of these task assignments a business may have difficulty in any of their operations.

The industry also lacks long-term strategic programs for enabling businesses to plan their long-term objectives. And more importantly than planning long term objectives is the more difficult task of implementing those plans and making them a longstanding modus operandi with which a company fastidiously adheres. The reason for this deficiency in the marketplace is similar: different businesses vary widely as are the variegated styles of personalities that drive them.

Therefore, what is needed in the art is a system, apparatus, and method of directing business operations both in its day-to-day operations and with its strategic endeavors. The system should be customizable to each businesses' needs, particular tastes, desired word choices, styles, as well as industry. The system should also be able to direct closed looped tasks such that details are handled with care and precision and that every step of a task or process proceeds in sequence to avoid missing various steps along the way.

The system should also be adaptable with various platforms, architectures, operating systems, and widely-used industry standard software applications. The system must integrate seamlessly with these software applications.

Moreover, the system should enable one to plan out their long term objectives through sound strategic thinking. The system should draw upon the experience and know-how of experienced business coaches. Likewise, the system should implement various business protocols such as Six Sigma in order to fully automate and streamline their business processes.

### SUMMARY OF THE INVENTION

It is an object of the present invention to provide a system, apparatus, and method of directing business operations in its day to day operations and its strategic endeavors. This system is designed to create closed loop workflows and to also monitor and assign the individual tasks of those workflows.

It is an object of the present invention to provide a system which is user-friendly by making it customizable to the user's needs and preferences. This is achieved through use of various wizards which ask a series of questions to adapt the system to the user's tastes.

It is an object of the present invention to provide a system which is adaptable with a wide array of platforms, architectures, operating systems, and widely used industry standard software applications. The system can integrate seamlessly with these software applications.

It is a further object of the present invention to provide a series of business modules which are used to support the user's business in various facets of their business. Examples of these facets include, but are not limited to: marketing, advertising, payroll, human resources, Six Sigma methodologies, and strategic business coaching.

### BRIEF DESCRIPTION OF THE DRAWING FIGURES

FIG. 1a is a block diagram of a preferred embodiment of the present invention.

FIG. 1b is a block diagram of a preferred embodiment of the present invention.

FIG. 2 is a plan view of a preferred embodiment of the present invention.

FIG. 3a is a plan view of a preferred embodiment of the present invention.

FIG. 3b is a plan view of a preferred embodiment of the present invention.

FIG. 4a is a block diagram of a preferred embodiment of the present invention.

FIG. 4b is a plan view of a preferred embodiment of the present invention.

FIG. 5a is a block diagram of a preferred embodiment of the present invention.

FIG. 5b is a block diagram of a preferred embodiment of the present invention.

FIG. 5c is a block diagram of a preferred embodiment of the present invention.

FIG. 6 is a block diagram of a preferred embodiment of the present invention.

FIG. 7a is a block diagram of a preferred embodiment of the present invention.

FIG. 7b is a plan view of a preferred embodiment of the present invention.

FIG. 7c is a plan view of a preferred embodiment of the present invention.

FIG. 8 is a block diagram of a preferred embodiment of the present invention.

### DESCRIPTION OF PREFERRED EMBODIMENTS

According to a preferred embodiment of the present invention, a unique system, apparatus, and method are used to maximize efficiency and organization within businesses and organizations. Moreover, the present invention also provides support and guidance to the business or organization with respect to goals, strategy, and higher abstract conceptual thinking. The system, apparatus, and method are described in enabling detail below.

For the purposes of the present invention the term “Internet” or “Network” shall be interchangeable. The term “Internet” shall refer to the information system which comprises the World Wide Web (www), the largest publicly accessible source of information in the world. The term “Network” shall refer to an intra-organizational cluster of computers or other device which are linked to each other.

For the purposes of the present invention the term “webpage” shall mean any page linked to a portal for the purpose of practicing the present invention. The term may be used in either a Network setting or when use with the Internet or World Wide Web.

For the purposes of the present invention the terms “task strip” and “task label” shall be interchangeable.

For the purposes of the present invention the term “computer” shall hereafter refer to those devices which are adaptable as a network appliance and are able to execute various software typically used in many businesses or other organizations. Several types of devices may be encompassed by the term “computer” which may include cellular telephones, personal digital assistants, laptop computers, or desktop computers.

For the purposes of the present invention the terms “organization” or “business” shall be interchangeable. The present invention is equally suitable for use with either non-profit organizations, public sector organizations and similar institutions because many public sector and/or non-profit functions and tasks are just as pertinent and essential as they are with private sector, for-profit businesses.

For the purposes of the present invention the terms “client-side” and “provider-side” shall refer to the line 200 which demarcates the side where a particular device is positioned or where a particular task is performed.

For the purposes of the present invention the term “client” can alternately refer to the owner, manager, or sole proprietor. Moreover, the term “client” can also refer to the business or organization as a whole. Therefore, when the system of the present invention communicates with an employee of the business, the term “employee” can be substituted for the client. In addition, the “client” can also refer to a machine such as a computer to perform a task at a pre-determined time. Therefore, the “client” need not be a human, but may alternatively refer to a machine.

For the purposes of the present invention the term “indicia” not only comprises printed illustrations, markings, bar codes and the like, but further comprises information which inheres with various magnetic fields or similar technology. For instance, the term “indicia” shall further comprise that information transmitted and received through use of near-field technology or similar technologies.

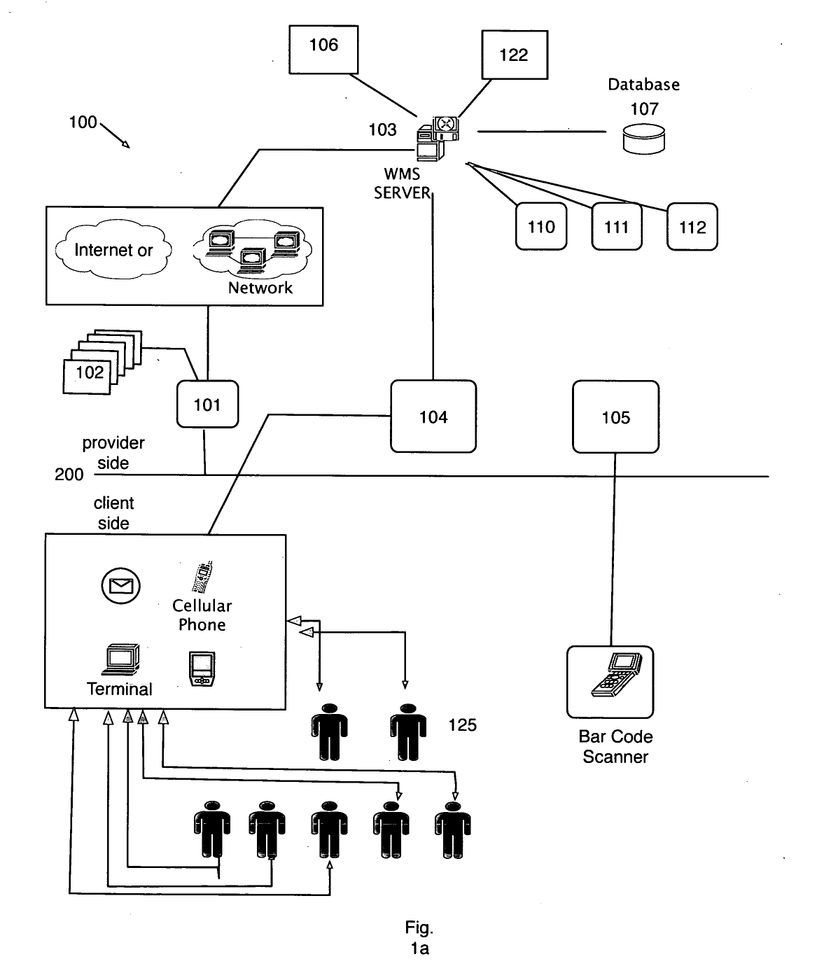

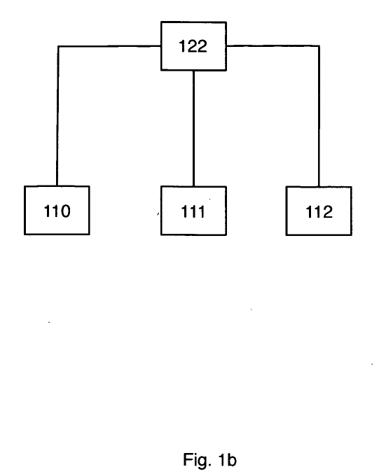

FIG. 1a illustrates one preferred embodiment of the present invention. The Network-based workflow management system 100 for directing closed-loop tasks for businesses and organizations includes a network based portal 101, webpages 102, business module 122 component, server 103, a notification alert system 104, system for receiving data inputs 105, a Measurements System 106, and a database 107.

The Network based portal is linked to a plurality of webpages 102 for the purpose of interfacing with a client. In some preferred embodiments this website may be utilized by the client on a subscription basis. The website may include a payment page which will enable a client to pay a subscription or setup fee using a credit card, debit card, or the like. The website may include its own wiring service or may use a third party service such as PayPal® (PayPal is a registered servicemark).

The business module 122 component is provided for the specialized purpose of supporting various business functions such as logistics, marketing, payroll, advertising, lead generation, or strategy. The business module component may comprise a business module wizard 110, a business module workflow 111, and a business module task manager 112 in some preferred embodiments as depicted in FIG. 1b. In operation, the business module wizard customizes the system to become more user-friendly to the client by using various terms, parlance, fonts, colors, etc. The wizard also asks the client fundamental structural information such as whether the business or organization is incorporated, whether it operates as an “S” or “C” status and the like. The wizard also asks the client identifying information such as name, phone numbers, addresses, email addresses, and the like. The wizard component is comprised of a plurality of questions directed to the client for the purpose of customizing a system module with appropriate parameters, parlance, and goals in order to make the system user-friendly and harmonized with client's software and hardware

The provider-side server 103 executes most of the operations of the present invention. The notification alert system 104 is used for notifying the client (i.e. employees, managers, independent contractors, etc.) to perform a specific task at a pre-determined time. The notification alert system is adapted to communicate to a client via a cellular phone, a pager, a personal digital assistant, email, or any suitable internet appliance. The system for receiving data inputs 105 receives various information from a client through client-side communications devices. The Measurements System 106 essentially records performance data derived by actual client tasks such as time taken to complete a project or six sigma (Six Sigma® is a registered servicemark and trademark of Motorola, Inc.) factors such as defects per million. The measurements system may further incorporate various algorithms for the purpose of organizing data, and tabulating the data as per user's preferences. The system database 107 is used for the purpose of storing system information.

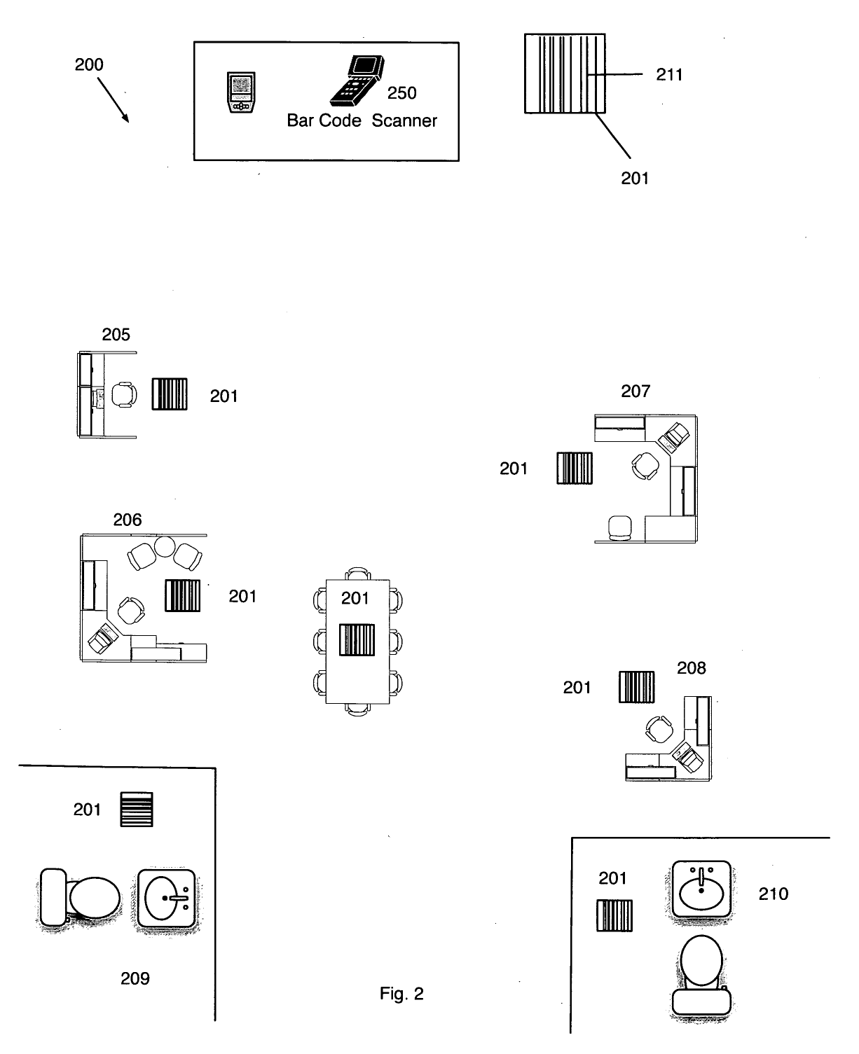

FIG. 2 illustrates a preferred embodiment which incorporates a task monitoring system 200. The task monitoring system incorporates a client-side task label 201 and a device 250 for reading the same. The task strip comprises indicia 211 for the purpose of identifying a plurality of data and is disposed at a job site nearby a task site. In task 1, operator is tasked with dusting off cubicles 1-5 (205, 206, 207, 208, 209, and 210). Placed at each task site is a task strip. After completing the tasks operator must scan the task strip. The scanning process accomplishes several functions. First, the scanning of the task strips is immediately relayed to the server and server will know that the task has been accomplished at a recorded time (the time the server received the transmission from the operator). Second, the scanning of the task strip informs the server which client, building, cubicle, and specific notes about that task has been completed by the operator. And third, the scanning of the task strip also informs the server which operator completed the task (via the scanning device rather than the indicia of the task strip).

In some preferred embodiments the task strip may be comprised of paper with bar codes imprinted thereon through use of ink. In other preferred embodiments the task strip may be a magnetized strip. And in other preferred embodiments the task strip may incorporate near field communication technology where an operator may just pass a near-field communication enabled cellular telephone over the task strip and the cellular phone can both scan the task strip and transmit/receive with the server. It will be apparent to one with skill in the art that other devices may prove suitable for accomplishing these functions. For these reasons, the present invention should not be construed as limiting in scope to these devices.

In the exemplary embodiment depicted in FIG. 2 a bar code scanner is used to scan the bar code. Some bar code scanners may incorporate a panoply of features such as inventory, communication to a server, etc. In those preferred embodiments where the device 250 does not incorporate a means of transmitting information to the server, a separate communications device 251 may also be incorporated.

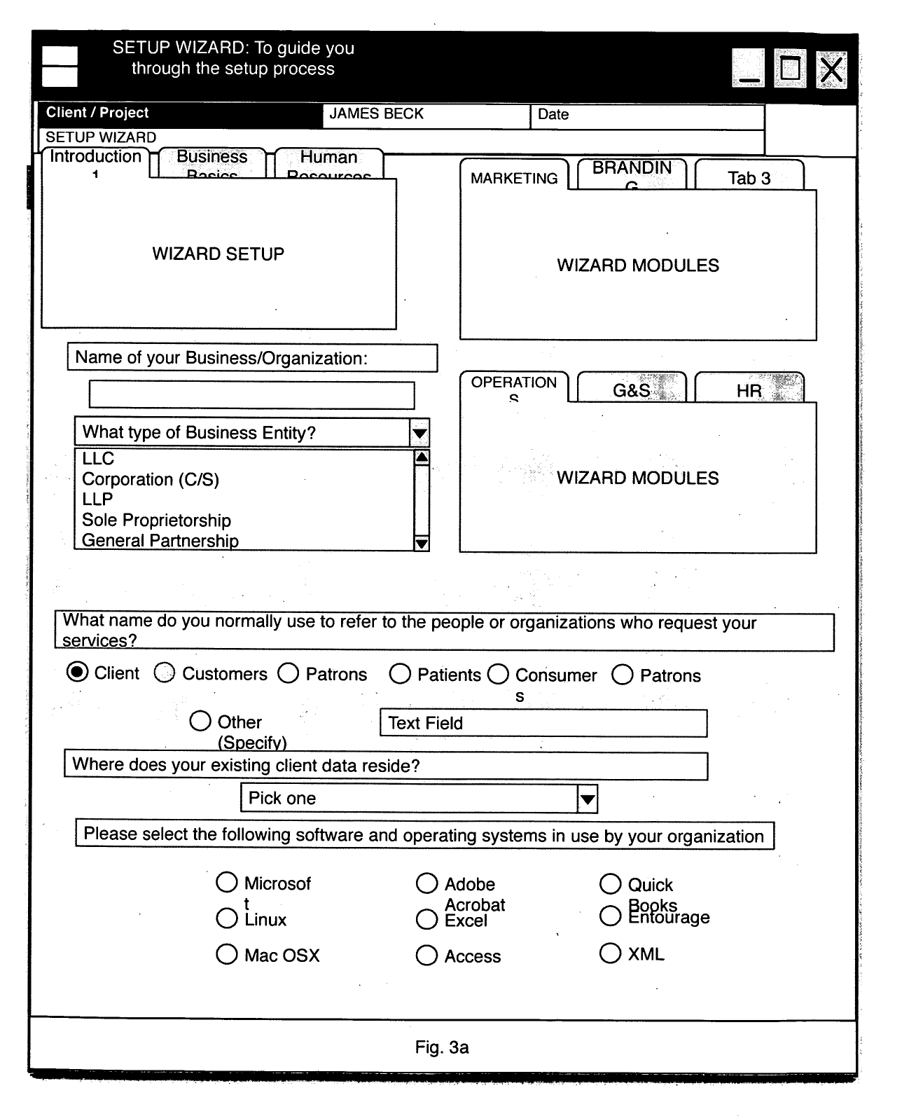

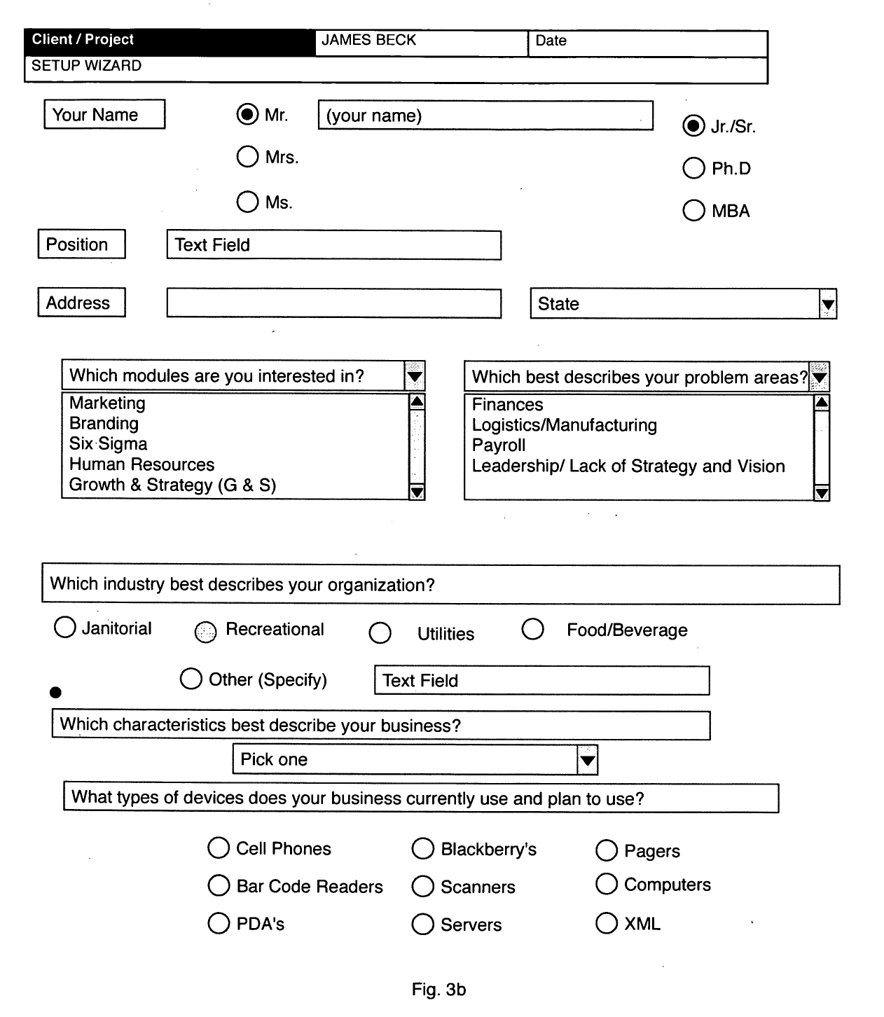

FIGS. 3a-3b illustrate an exemplary setup wizard 300 according to a preferred embodiment of the present invention. Setup wizard is used to customize and tailor the system to the user's preferences. Preferences include among the following: terms to use (e.g. “do you call your customers: a. clients, b. patrons, c. guests, 4. Students, or 5. Users), which aspects of the user's business the system is to support, methods of bookkeeping or accounting, tax status, type of business entity, etc. Upon receiving the answers from the user, the setup wizard adapts the relevant components of the system as per user's preferences.

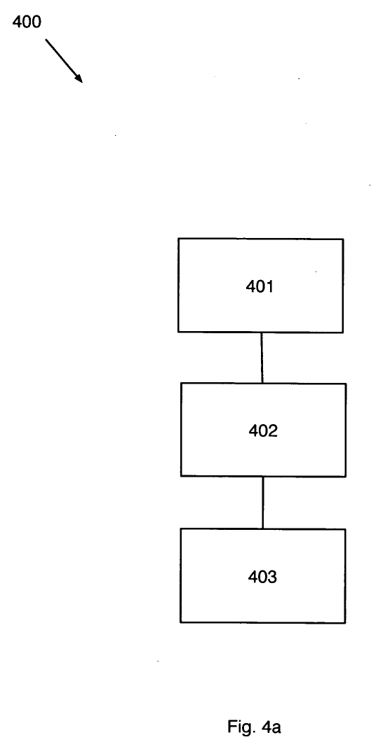

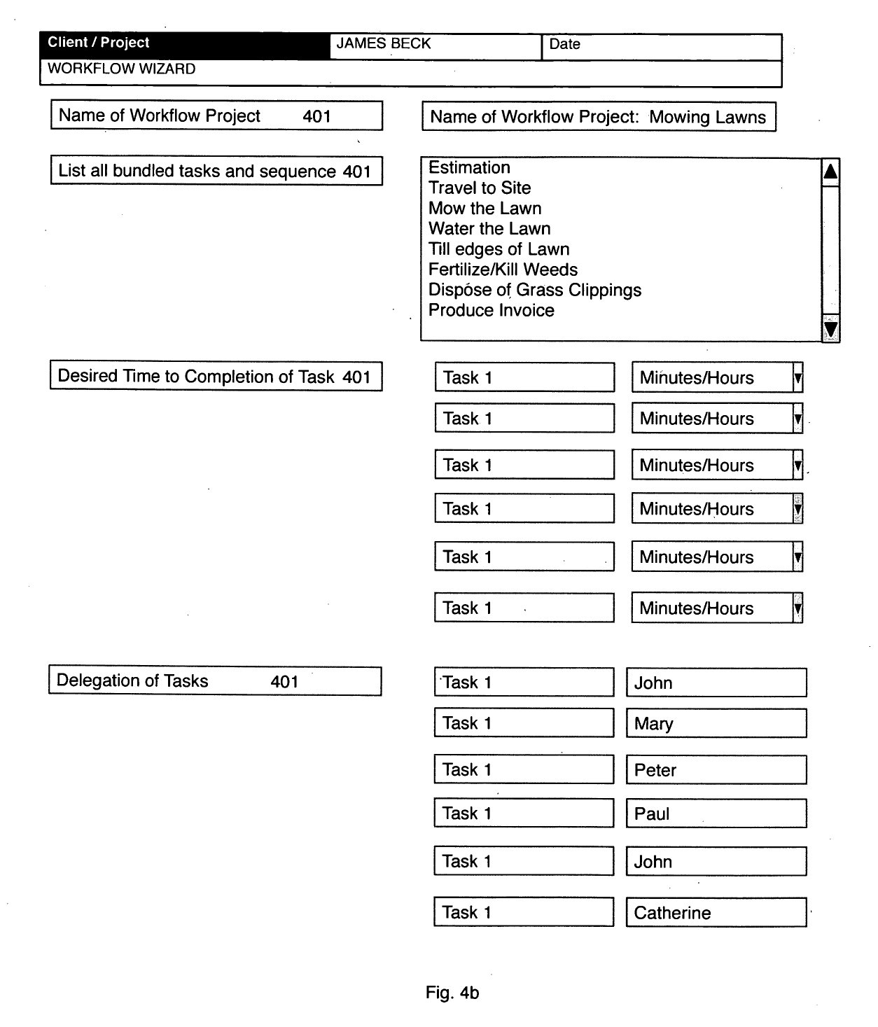

FIG. 4 illustrates a workflow module which includes a workflow wizard 401, workflow designer 402, and a workflow 403. The workflow wizard illustrated in FIG. 4b comprises a series of questions directed to a client to list constituent tasks or activities required to complete a specific project. Additionally, the workflow wizard might inquire in some embodiments to whom or what the listed tasks or activities are delegated. Moreover, the workflow wizard may ask another set of questions regarding task parameters. Examples of task parameters may include timeliness specifications, due date, and the like.

Based upon the information the client gave the workflow wizard, the workflow designer 402 creates a workflow 403 based upon the client's inputs to said questions. This workflow is subsequently used by the task manager 500 in defining the operations, sequence, decision trees, and delegation rules by which to operate.

In order to illustrate the inter-connectivity of the various modules and wizards the parameter “pre-determined time” is used as an example. The pre-determined time of a particular task may be chosen by the client through the workflow wizard phase. Or, in some other preferred embodiments, the system may decide in one of its modules or components that there may be a more optimal time for performing the task. For instance, if a finance module were to decide that the pre-determined time for executing a task is better during the day because the client may save money due to the fact that evening hours require union-mandated overtime. Or, in some instances a risk management module may decide that a particular task is more safely performed in evening hours when there are fewer people to be endangered by particular task. Therefore, the present invention may be configured in some preferred embodiments to override each other in order to maximize efficiency or other goals desirable to the client. The possibilities are endless.

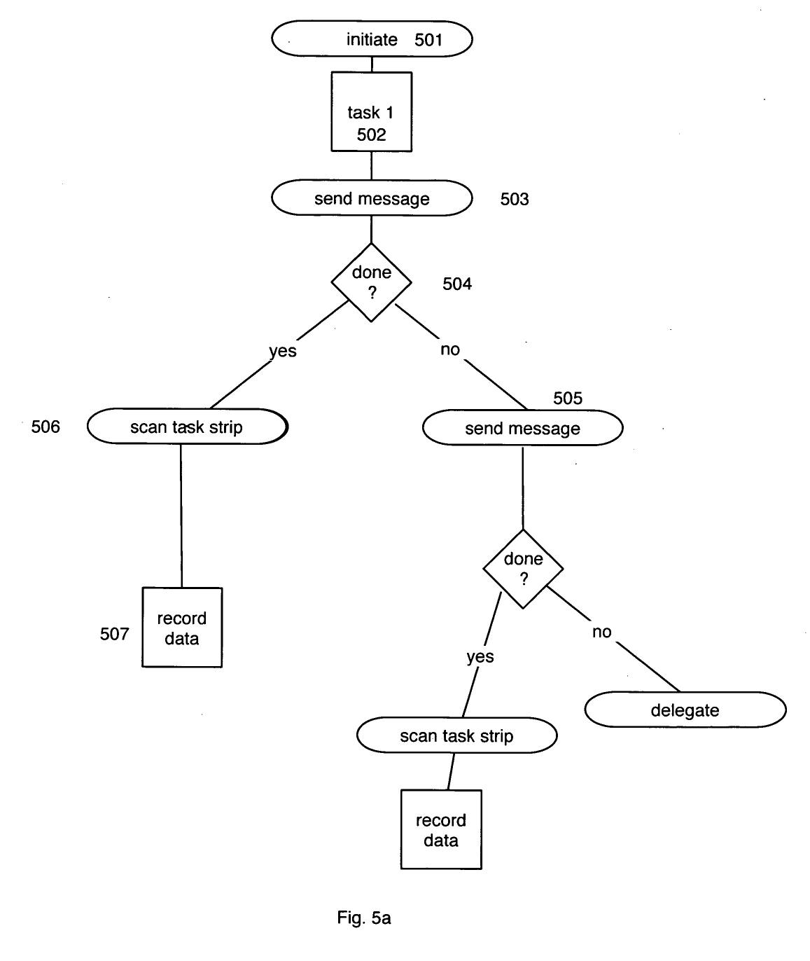

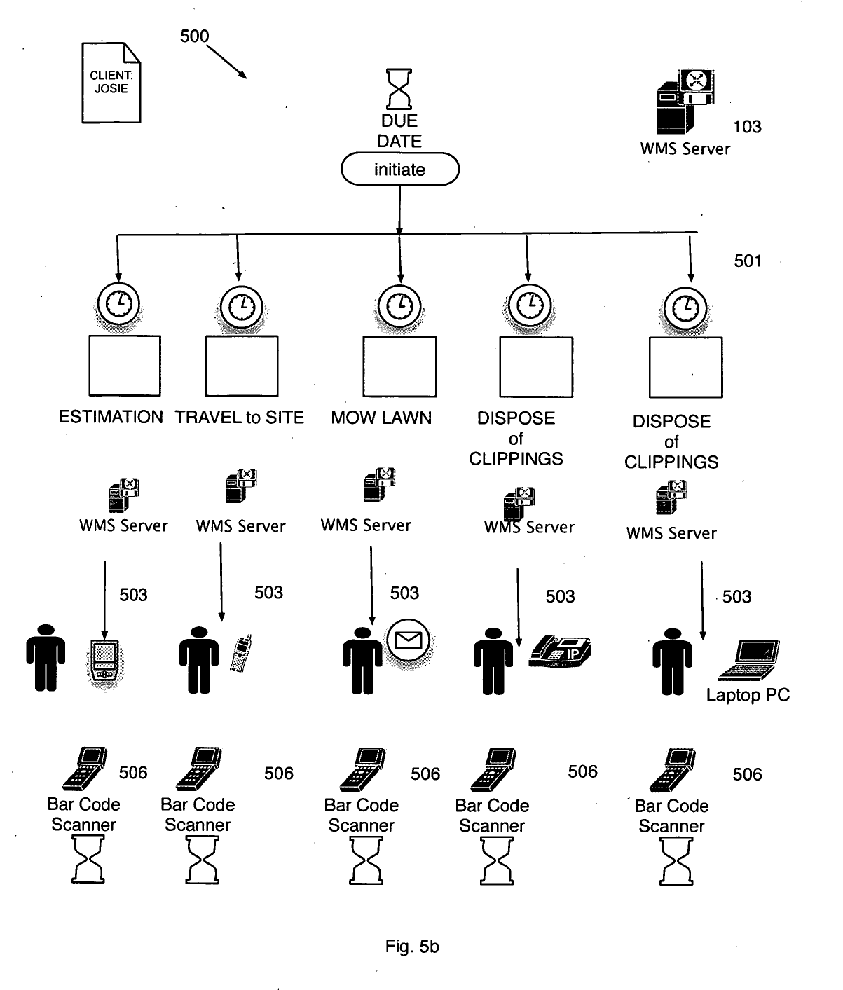

FIG. 5a illustrates an exemplary Task Manager 500 in one preferred embodiment. The task manager is informed by the workflow designer and is in communication with the notification alert system. The task manager 500 is one of the principal modules of the present invention. The task manager is used for assigning tasks to the client at a pre-determined time. Using the workflow created by the workflow manager, the task manager directs the client to perform tasks at pre-determined times. This communication takes place through the notification alert system.

In step one 501 the task manager initiates a project. At a pre-determined time, the task manager sends a message 503 to the client's operators to perform a task 502. After a predetermined amount of elapsed time the server decides 504 whether the task has been accomplished. The server will know if the task has been accomplished if and when the operator scans the task strip 506 thereby notifying the server that the task has been accomplished. Thereafter, the server records 507 the data regarding the task. In the event the server decides that the task has not been completed, the server will send another message 505 to the same operator and repeat the process until the task has been completed.

Alternatively, if the task has not finished the server may send a message to another operator to perform the task (or perhaps to summon another operator for help expediting the task). After a certain pre-determined amount of elapsed time the server will again decide whether the task has been completed. It should be noted that in some preferred embodiments the task manager may issue another follow up/investigate/inspect command to another operator. This operator may inspect and grade the work the previous operators had accomplished.

FIG. 5b is another flow diagram illustrating the task manager in further detail. In this example, the task manager directs several different employees to perform specific tasks all of which are required to complete a project.

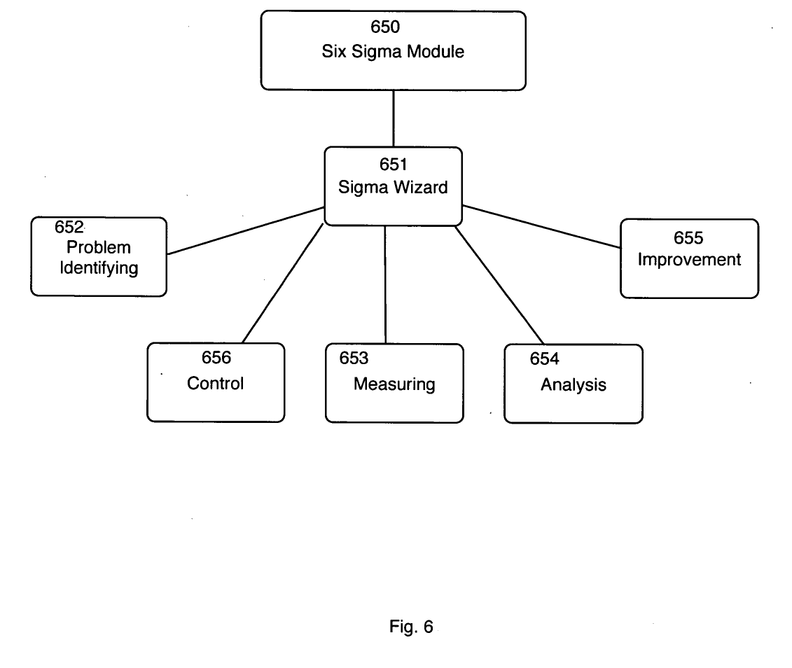

FIG. 6 illustrates a preferred embodiment wherein the system utilizes Six Sigma methodologies in order to increase efficiency, decrease defects, and thereby increase productivity. The Six Sigma module 650 consists of the following components: a six sigma wizard 651, a problem identifying component 652, a measuring component 653, an analysis component 654, and improvement component 655, and a control component 656.

The six sigma wizard component merely sets up the components to customize the components for the purpose of becoming more user-friendly. The first component asks the client a number of questions to attempt to pinpoint the source of a problem and thereby formulate a problem statement. The measuring component is used to establish a measure of the current performance of a particular area of your business. The analysis component is used to identify and isolate the critical factors of your current business systems show the most promise for improvements. The improvement module is used to work with the client to formulate concrete steps and actions the business may take to improve those critical few details to improve business. And the control component is designed to congeal, or maintain a longstanding protocol or practice of maintaining the new business practices.

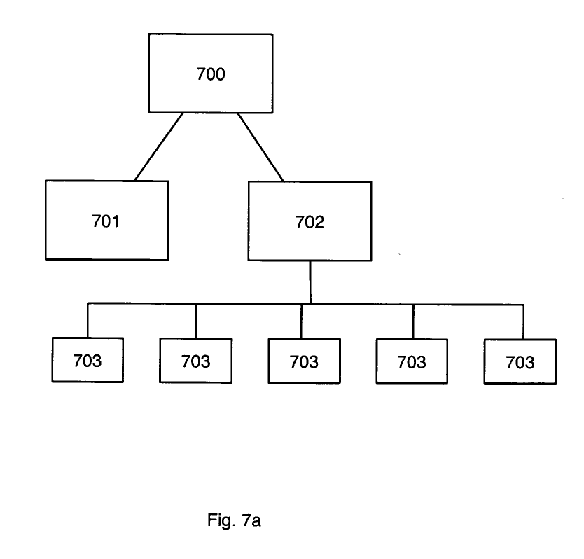

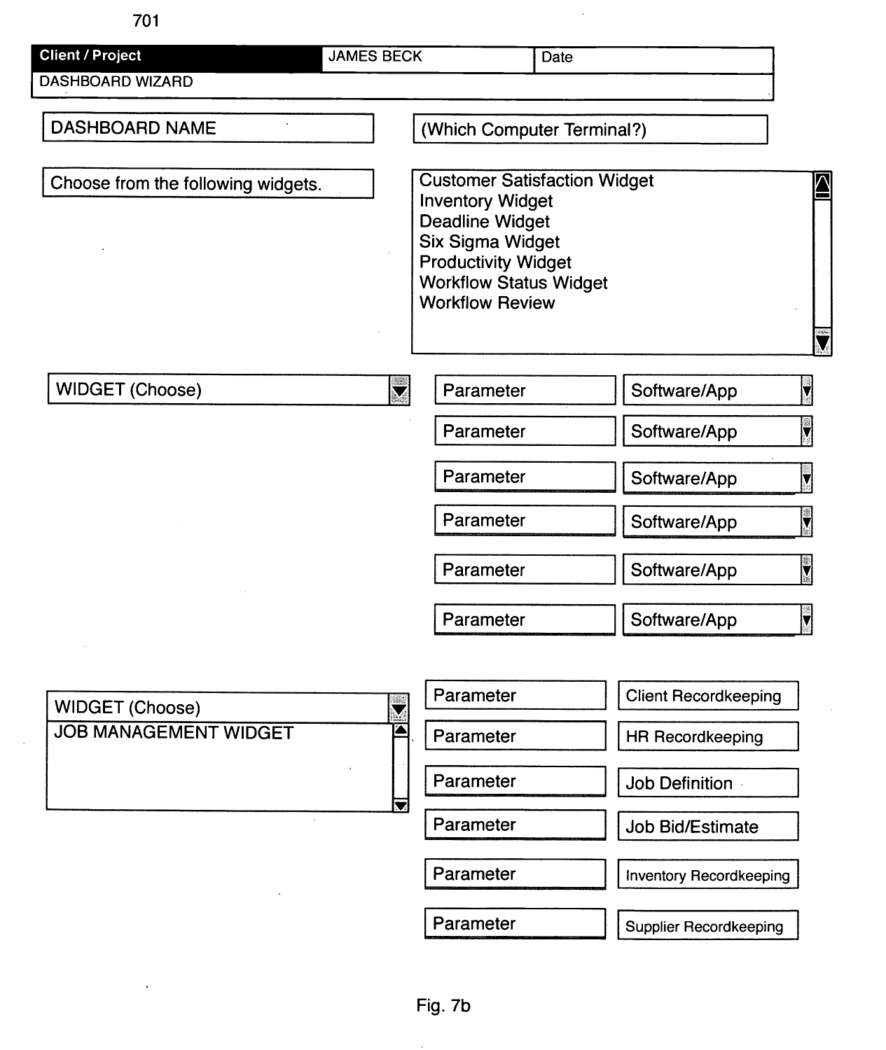

FIGS. 7a, 7b and 7c illustrate a preferred embodiment whereby a dashboard module 700 is incorporated into the system. The dashboard 702 is used for enabling a user to take a “snapshot” or acquire a “bird's eye view” of various business systems such as inventory, logistics, human resources, cash, stock trends and the like. The dashboard can give the client a real-time view of those business systems which may be represented by the widgets 703. For instance, one dashboard widget 703 can tell a client in real time their current inventory levels. Or in some cases, the dashboard widget can quickly show the exact location of their trucks delivery routes in transit. Typically, this dashboard will be prominently displayed upon the periphery of the monitor of a screen.

FIG. 7b illustrates one preferred embodiment where the dashboard module comprises a dashboard wizard 701 for the purpose of setting up and customizing the widgets. The wizard may ask which types of software and the location of files or data from which the widget may use in order to illustrate a picture or a number to give the client a useful view of that particular business system.

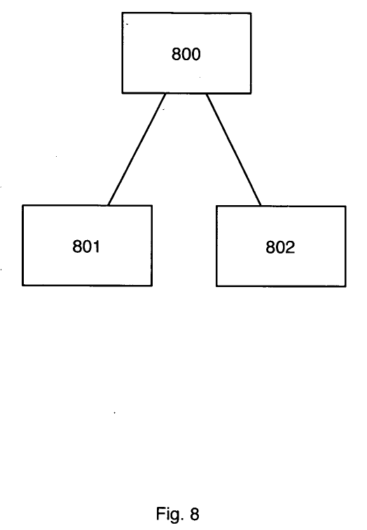

FIG. 8 illustrates a preferred embodiment where the present invention may further include a security system 800. This security system includes an authorization component 801 and an encryption component 802. The authorization component ensures that the operator has requisite access given by the client through use of a username and password system. In other preferred embodiments authorization can be granted through special keys, biometric technologies, etc. The possibilities are endless.

The encryption component is used to secure various transactions and information disclosures to third parties. This encryption component will be suitable when the portal includes a payment page.

Those skilled in the art will appreciate numerous variations in the present system, configuration and operation that are within the scope of the invention. Those skilled in the art will also appreciate how the principles illustrated in these preferred embodiments can be used in other examples of the invention. A particular reference number in one figure refers to the same element in all of the other figures.

Moreover, It will be apparent to the skilled artisan that there are numerous changes that may be made in embodiments described herein without departing from the spirit and scope of the invention. As such, the invention taught herein by specific examples is limited only by the scope of the claims that follow.

What is claimed is:

1. A comprehensive network-based workflow management system for directing closed-loop tasks for businesses and organizations comprising:
a network based portal linked to a plurality of webpages for the purpose of interfacing with a client, at least one business module component, a provider-side server, a plurality of Instructions for the purpose of directing pre-determined tasks, a notification alert system for notifying the client to perform a specific task at a pre-determined time, a system for receiving data inputs from a client through a second communication device, a Measurements System for tracking data inputs, a task manager for directing a person or machine to perform a task at a pre-determined time, and a provider-side database for the purpose of storing system information.

2. The comprehensive network based workflow management system for directing closed loop tasks for businesses further comprising a wizard component; the wizard component is comprised of a plurality of questions directed to the client for the purpose of customizing a system module with appropriate parameters, parlance, and goals in order to make the system user-friendly and harmonized with client's software and hardware.

3. The comprehensive network based workflow management system for directing closed loop tasks for businesses and organizations wherein the notification alert system is adapted to communicate to a client via a cellular phone, a pager, a personal digital assistant, email, or an internet appliance.

4. The comprehensive network based workflow management system for directing closed loop tasks for businesses or organizations further comprising a client-side task strip; the task strip comprises indicia for the purpose of identifying a plurality of data and is disposed at a job site nearby a task site.

5. The comprehensive network based workflow management system for directing closed loop tasks for businesses or organizations further comprising a workflow wizard and a workflow manager;
the workflow wizard comprises a first plurality of questions directed to a client to enumerate constituent tasks or activities required to complete a specific project and to whom or what the constituent tasks or activities are delegated and a second plurality of questions regarding task parameters; the workflow manager creates a workflow based upon the client's inputs to said questions.

6. The comprehensive network based workflow management system for directing closed loop tasks for businesses or organizations further comprising a task manager for assigning tasks to the client at a pre-determined time, the task manager is informed by the workflow manager and is in communication with the notification alert system.

7. The comprehensive network based subscription workflow management system for directing closed loop tasks for businesses or organizations wherein the task manager comprises the following steps:
(1.) disseminating at least one task to a first operator through the notification alert system at a predetermined time from the server; (2.) scanning a task strip upon completion of the task assigned by the task manager by the client, (3.) transmitting data from task strip to system through the system for receiving data inputs (4) re-tasking or summoning a subsequent operator or and additional operator when a task has not been completed according to the parameters of the workflow manager and 5.) transmitting data from task strip to system through the system for receiving data inputs when the task has been completed, and 6.) recording predetermined data requested by the Measurements System.

8. The comprehensive network based workflow management system of claim 1 further comprising a six sigma module component wherein the six sigma module component comprises a six sigma wizard, a problem identifying component, a measuring component, an analysis component, and improvement component and a control component.

9. The comprehensive network based workflow management system of claim 1 further comprising a dashboard module, the dashboard module comprises a dashboard wizard and a plurality of dashboard widgets; the dashboard widgets are paired with a plurality of parameters and software applications.

10. The comprehensive network based workflow management system of claim 1 further comprising a security system; security system includes an authorization component and an encryption component; the authorization component ensures that the operator has requisite access given by the client through use of a username and password system; the encryption component is used to secure various transactions and information disclosures to third parties.

11. The comprehensive network based workflow management system of claim 1 further comprising: a communication device for the purpose of sending information from the indicia of the task strip to the server.

12. The comprehensive network based workflow management system of claim 1 further comprising a security system; the security system comprises an authorization component and an encryption component.

13. The comprehensive network based workflow management system of claim 1 further comprising a bar code scanner.

14. The comprehensive network based workflow management system of claim 4 wherein the indicia are a plurality of bar codes.

15. The comprehensive network based workflow management system of claim 1 further comprising a strategy module.

16. The comprehensive network based workflow management system of claim 1 further comprising a logistics module.

17. The comprehensive network based workflow management system of claim 1 further comprising a marketing module.

18. The comprehensive network based workflow management system of claim 1 wherein the measurements system comprises an algorithm for the purpose of organizing information and tabulating information.

19. The comprehensive network based workflow management system of claim 1 further comprising a payroll module.

20. A comprehensive network-based workflow management system for directing closed-loop tasks for businesses and organizations comprising:
a network based portal linked to a plurality of webpages for the purpose of interfacing with a client, a logistics module, marketing module, and a strategy module, a provider-side server, a plurality of Instructions for the purpose of directing pre-determined tasks, a notification alert system for notifying the client to perform a specific task at a pre-determined time, a system for receiving data inputs from a client through a second communication device, a Measurements System tracking data inputs, a task manager for directing a person or machine to perform a task at a pre-determined time, and a provider-side database for the purpose of storing system information.
